(19) United States
(12) Patent Application Publication
(10) Pub. No.: US 2012/0251987 A1
(43) Pub. Date: Oct. 4, 2012

(54) SYSTEM AND METHOD FOR VIRTUAL REALITY SIMULATION OF LOCAL DENTAL ANESTHESIOLOGICAL TECHNIQUES AND SKILLS TRAINING

(76) Inventors: Ta-Ko Huang, Kaohsiung City (TW); Zong-Han Lyu, Kaohsiung City (TW)

(21) Appl. No.: 13/515,781

(22) PCT Filed: Oct. 28, 2010
(86) PCT No.: PCT/CN2010/001714

§ 371 Date: Jun. 13, 2012

(51) Int. Cl. G09B 19/00

(52) U.S. Cl. 434/219

(57) ABSTRACT

A method includes: (1) providing a system for virtual reality simulation of local dental anesthesiological techniques and skills training; (2) building an operator injecting process by using the system for virtual reality simulation of local dental anesthesiological techniques and skills training; (3) digitalizing the operator injecting process by using the system for virtual reality simulation of local dental anesthesiological techniques and skills training; (4) comparing the digitalized data and a standard needle-penetration process, and digitally displaying the difference between the digitalized data and standard needle-penetration process through the display unit; (5) calculating the digitalized data of the difference between the digitalized data and the standard needle-penetration process to obtain an analysis result by using the data processing unit of the system for virtual reality simulation of local dental anesthesiological techniques and skills training; and (6) outputting the analysis result and displaying the analysis result on the display unit.

### BACKGROUND

1. Field of the Invention

The present invention relates to a system and method for virtual reality simulation of local dental anesthesiological techniques and skills training, and more particularly to a system for virtual reality simulation of local dental anesthesiological techniques and skills training employing an optical positioning device that is capable of assisting the position-tracking of the syringe and head model, to make sure that the student's gesture and position are correct when practicing anesthetic injection while avoiding subjective judgment, thereby achieve objectivity and increase accuracy of the analysis data.

2. Related Art

Nerve blocking anesthetics is commonly used in dental clinics for preventing the patients from uncomfortable experience and thereby allowing the treatment to complete successfully. Since it takes one to two hours for the anesthetics to wear off, patients would have a numbness feeling on their lips and cheeks. The nerve blocking anesthetics method is safer comparing to general anesthetics method. Although there is no official report showing statistic data of uncomfortable experience or accidents occurred after nerve blocking anesthetics, there are no doubt that some of the cases do happen in Taiwan. That is, nerve blocking anesthetics method still has its risks and should not be underestimated.

Dental anesthetics method includes inhaling nitrous oxide (laughing gas) or intravenous injection for sedation anesthetics, and inhalational general anesthetics used on the disabled, the uncooperative children, or those patients who fear extremely for dental treatments.

However, the current oral nerve blocking anesthetics training for the dental students is that the students perform analog injection with an injecting device on the model, and the teachers evaluate by naked eyes that whether the student's gesture and position are correct.

Since the judgment for gesture and position is made by naked eyes, it varies from person and often seemed to be too subjective. Further, the students are not informed immediately when they make a mistake, hence they could not adjust their performance right away, nor could they check the offset situation of the needle-penetration and needle-insertion point during the injection process, evaluate whether the performance met the standard, determine the accuracy and quality of the process, and could not save the record for entire performing process to create an integrated learning course. That is, the students could not obtain a full understanding of their mistakes.

According to prior arts, there exists technology for interactively tracking the position of medical device; for instance, the U.S. Pat. No. 5,617,857 (Imaging System Having Interactive Medical Instruments And Methods) disclosed an imaging system and the method thereof. The imaging system includes a medical device and a transmitter transmitting detectable energy. By further employing a detector and a processor, the location of the medical device may be detected.

U.S. Pat. No. 6,640,128 (Method And Device For The Navigation-Assisted Dental

Treatment) disclosed a method for assisting dental treatment. First, provide a 3D data set of the patient's teeth and mandible area. Then, a computer aided navigation or tracking system uses that data set to make a record of the patient's teeth and mandible area. Comparing to the computer aided navigation or tracking system, the medical device or equipment may be recorded.

However, the aforementioned prior art may not be upgraded together with the conventional dental devices. For example, it may not be employed with the commonly used dental operating table and dental jackhammer (hand tool). Further, the technology of the aforementioned prior art is not adjustable according to the user's habits. Moreover, the technology of the prior art may not position and rectify the device by the help of personal computers. This result in high cost on changing systems, thereby limited its potential in the market.

The inventor of the present invention also disclosed in TW Patent Application No. 097113976 (Clinical dentistry and teaching training analog tracking system and evaluation method thereof) a motion tracking device by using low-cost camera creating 3D surgical instruments. The disclosed device is capable of upgrading using current equipment. Further, it is adjustable according to the user's operating preference (such as left-handed or right-handed), and capable of using automatic means to improve traditional manual comparison method, thereby enhance the accuracy and convenience for dentist training.

However, the aforementioned training aiding device does not provide appropriate equipment for oral anesthetics training. Therefore, the inventor of the present invention disclose a method for tracking position of syringe and head model by using the positioning algorithm, to assess whether the gesture and position are correct when the students injects the anesthetics. Further, the present invention employs simulating element, making the practicing process as similar to the realistic clinical situation as possible, thereby minimizing the risk of patients being uncomfortable or occurrence of accidents after injection of nerve blocking anesthetics.

### SUMMARY

In order to overcome the aforementioned deficiencies, an object of the present invention is to provide a system and method for virtual reality simulation of local dental anesthesiological techniques and skills training. The present invention employs an optical tracking method to perform positioning, uses spatial orientation technology to simplify the image processing process, assists tracking the positions of the syringe and head model, and save the operating process to allow the user to improve their performance according to the operating process, thereby forming a complete data analysis process, avoiding subjective judgment, in order to achieve objectivity and increase evaluation accuracy.

Another object of the present invention is to provide a system and method for virtual reality simulation of local dental anesthesiological techniques and skills training; wherein the present invention is used for dental clinical training, operating and evaluation, and by using simulating element, the practicing process is made to be as similar to the realistic clinical situation as possible.

The present invention provides a system for virtual reality simulation of local dental anesthesiological techniques and skills training including:

a positioning unit;

a syringe, having relative movement with the positioning unit, and includes a plurality of positioning points; and

an optical analysis device, including a data processing unit, a display unit and an optical positioning module, wherein the display unit and the optical positioning module are electrically connected to the data processing unit, the optical positioning module includes a plurality of optical capturing component for optically scanning the positioning unit and the positioning points of the syringe to output obtained data to the data processing unit.

The method for virtual reality simulation of local dental anesthesiological techniques and skills training according to the present invention comprises steps of:

(1) providing a system for virtual reality simulation of local dental anesthesiological techniques and skills training including: a positioning unit; a syringe, having relative movement with the positioning unit, and includes a plurality of positioning points; and an optical analysis device, including a data processing unit, a display unit and an optical positioning module, wherein the display unit and the optical positioning module are electrically connected to the data processing unit, the optical positioning module includes a plurality of optical capturing component for optically scanning the positioning unit and the positioning points of the syringe to output obtained data to the data processing unit;

(2) building an operator injecting process by using the system for virtual reality simulation of local dental anesthesiological techniques and skills training;

(3) digitalizing the operator injecting process by using the system for virtual reality simulation of local dental anesthesiological techniques and skills training;

(4) comparing the digitalized data and a standard needle-penetration process, and digitally displaying the difference between the digitalized data and standard needle-penetration process through the display unit;

(5) calculating the digitalized data of the difference between the digitalized data and the standard needle-penetration process to obtain an analysis result by using the data processing unit of the system for virtual reality simulation of local dental anesthesiological techniques and skills training; and

(6) outputting the analysis result and displaying the analysis result on the display unit.

As the foregoing, the present invention has advantageous effect in that, by using positioning algorithm method, it provides method for tracking position of syringe and head model to assess whether the gesture and position are correct when the students injects the anesthetics. Further, the present invention employs simulating element, making the practicing process as similar to the realistic clinical situation as possible, thereby minimizing the risk of patients being uncomfortable or occurrence of accidents after clinical nerve blocking anesthetics injections.

### BRIEF DESCRIPTION OF THE DRAWINGS

FIGS. 1A, 1B, and 1C are drawings illustrating the system for virtual reality simulation of local dental anesthesiological techniques and skills training according to the present invention; and

FIG. 2 is a flow chart illustrating the method for virtual reality simulation of local dental anesthesiological techniques and skills training according to the present invention.

### DETAILED DESCRIPTION OF THE EMBODIMENTS

The disclosed embodiments and advantages thereof are best understood by referring to the illustrated figures. It will be understood that the following description is not intended to limit the invention to the form disclosed herein.

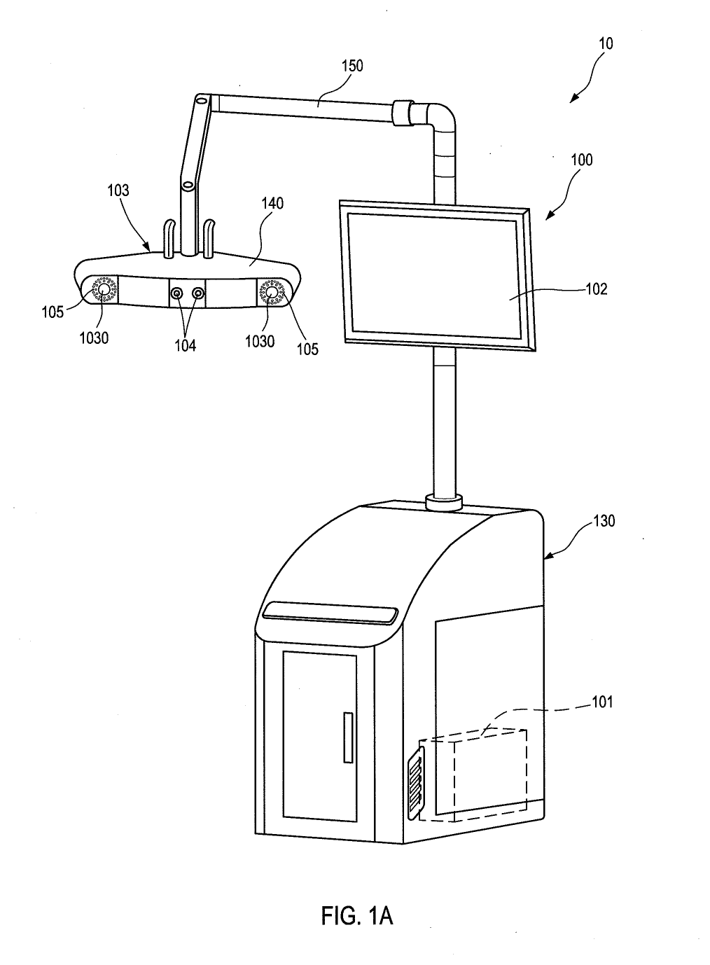

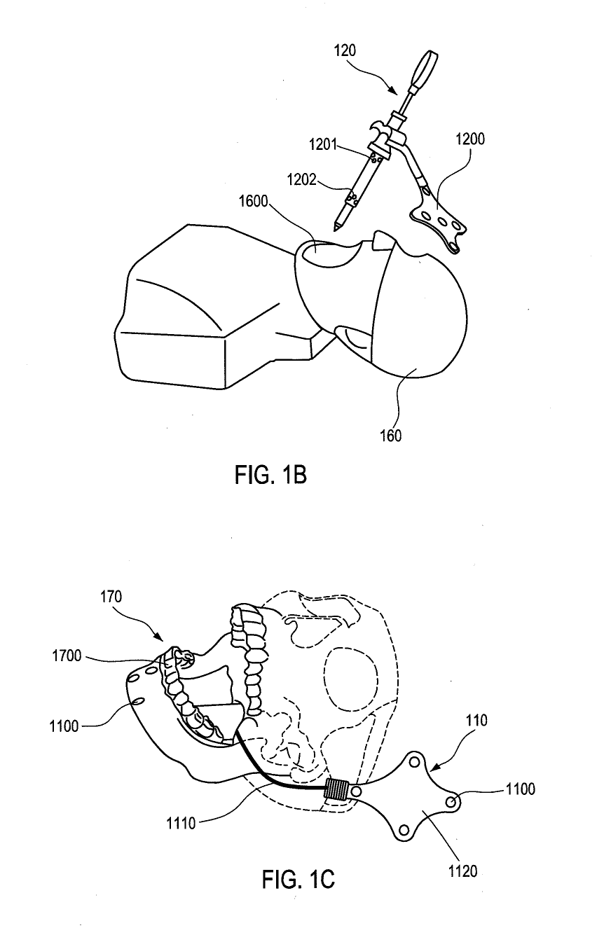

FIGS. 1A, 1B, and 1C are schematic views illustrating the system for virtual reality simulation of local dental anesthesiological techniques and skills training according to the present invention. As shown in the figures, the system for virtual reality simulation of local dental anesthesiological techniques and skills training 10 includes: a positioning unit 110 including a positioning member 1120, a hanging structure 1110 connecting the positioning member 1120, and a plurality of marking points 1100 disposed at the positioning member 1120, wherein the marking points 1100 are LEDs or light-reflecting marks; a syringe 120, having relative movement with the positioning unit 110, and includes a plurality of positioning points 1200 externally attached thereto, wherein the positioning points 1200 are light-reflecting marks disposed at the syringe 120, including a first positioning point group 1201 provided at one end of the syringe 120 and a second positioning point group 1202 provided at another end of the syringe 120, wherein the first positioning point group 1201 and the second positioning point group 1202 are arranged at the two ends of the syringe 120 in a manner of derangement, stagger arrangement, or annular arrangement; and an optical analysis device 100 including a data processing unit 101, a display unit 102 and an optical positioning module 103, wherein the display unit 102 and the optical positioning module 103 are electrically connected to the data processing unit 101, the optical positioning module 103 includes a plurality of optical capturing component 1030 for the marking points 1100 of the optically scanning the positioning unit 110 and the positioning points 1200 of the syringe 120 to output data to the data processing unit 101, wherein the optical capturing component 1030 according to the present embodiment is an optical camera. The system for virtual reality simulation of local dental anesthesiological techniques and skills training 10 further includes a first optical analysis device case 130, a second optical analysis device case 140 and a light arm set 150; wherein the data processing unit 101 is accommodated inside the first optical analysis device case 130, the optical positioning module 103 is disposed inside the second optical analysis device case 140, and the light arm set 150 is fixed to the first optical analysis device case 130 and movably attached to the second optical analysis device case 140 and the display unit 102. Besides, the optical analysis device 100 further includes a plurality of light-emitting units 105 and a plurality of laser-emitting units 104 disposed at the first optical analysis device case 130 and electrically connected to the data processing unit 101; wherein the laser-emitting units 104 emit laser beam to the operating region to confirm the direction of the optical positioning module 103, and the light-emitting units 105 is used to supply sufficient light for the operating region. Moreover, the system for virtual reality simulation of local dental anesthesiological techniques and skills training further includes a head model member 160 and a tooth and jaw model 170, wherein the positioning unit 110 is connected to the tooth and jaw model 170. The head model member 160 includes an oral cavity 1600, wherein the tooth and jaw model 170 is movably disposed inside the oral cavity 1600, and an artificial oral soft tissue 1700 is movably disposed at the tooth and jaw model 170. Alternatively, the positioning unit 110 may be disposed directly in the tooth and jaw model 170. The head model member 160 and the tooth and jaw model 170 are accessories for analog injection.

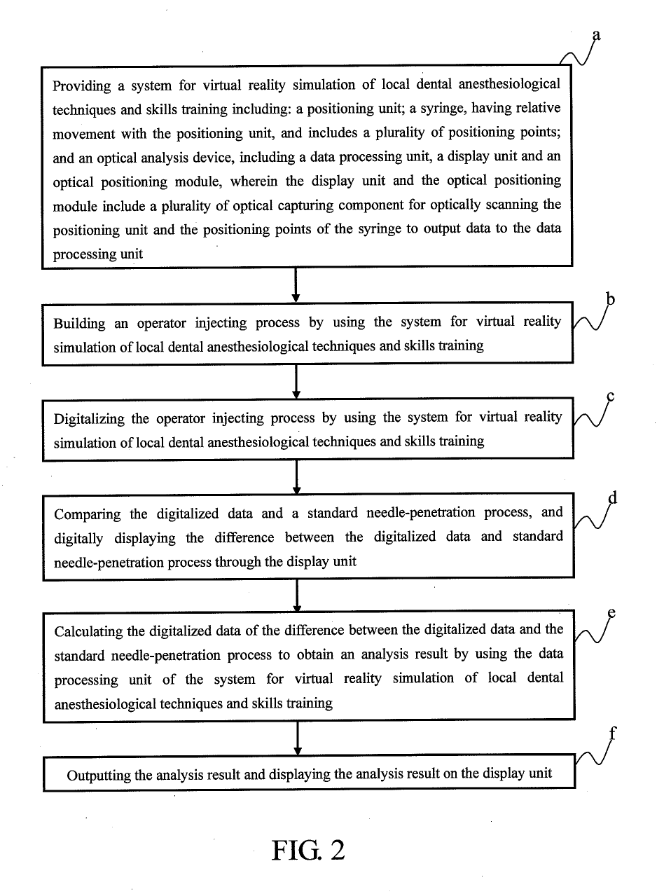

FIG. 2 is a flow chart illustrating the method for virtual reality simulation of local dental anesthesiological techniques and skills training according to the present invention. As shown in FIG. 2, the method for virtual reality simulation of local dental anesthesiological techniques and skills training includes:

Step (1)a: providing a system for virtual reality simulation of local dental anesthesiological techniques and skills training including: a positioning unit; a syringe, having relative movement with the positioning unit, and includes a plurality of positioning points; and an optical analysis device, including a data processing unit, a display unit and an optical positioning module, wherein the display unit and the optical positioning module are electrically connected to the data processing unit, the optical positioning module includes a plurality of optical capturing component for optically scanning the positioning unit and the positioning points of the syringe to output data to the data processing unit;

Step (2)b: building an operator injecting process by using the system for virtual reality simulation of local dental anesthesiological techniques and skills training;

Step (3)c: digitalizing the operator injecting process by using the system for virtual reality simulation of local dental anesthesiological techniques and skills training;

Step (4)d: comparing the digitalized data and a standard needle-penetration process, and digitally displaying the difference between the digitalized data and standard needle-penetration process through the display unit.

Step (5)e: calculating the digitalized data of the difference between the digitalized data and the standard needle-penetration process to obtain an analysis result by using the data processing unit of the system for virtual reality simulation of local dental anesthesiological techniques and skills training; and

Step (6)f: outputting the analysis result and displaying the analysis result on the display unit.

Wherein, the aforementioned difference includes offset situation assessment of the needle-penetration and needle-insertion point, and whether the operate performance meets the standard requirement. The operating process includes error feedback, so the user is informed in time that a mistake is made and thus able to adjust his or her operating method according to the feedback. The operator injection process includes point of needle-penetration, angle of needle-penetration, direction of needle-penetration, and depth of needle-penetration.

The previous description of the preferred embodiment is provided to further describe the present invention, not intended to limit the present invention. Any modification apparent to those skilled in the art according to the disclosure within the scope will be construed as being included in the present invention.

1. A system for virtual reality simulation of local dental anesthesiological techniques and skills training comprising:
a positioning unit;
a syringe, having relative movement with the positioning unit, and includes a plurality of positioning points;
an optical analysis device including a data processing unit, a display unit and an optical positioning module, wherein the display unit and the optical positioning module are electrically connected to the data processing unit, the optical positioning module includes a plurality of optical capturing component for optically scanning the positioning unit and the positioning points of the syringe to output data to the data processing unit; and
a head model member and a tooth and jaw model, wherein the positioning unit is connected to the tooth and jaw model, the head model member includes an oral cavity, and the tooth and jaw model is movably disposed inside the oral cavity.

2. The system of claim 1, further comprising a first optical analysis device case, a second optical analysis device case and an light arm set; wherein the data processing unit is accommodated inside the first optical analysis device case, the optical positioning module is disposed inside the second optical analysis device case, and the light arm set is fixed to the first optical analysis device case and movably attached to the second optical analysis device case and the display unit.

3. The system of claim 2, wherein the optical analysis device further includes a light-emitting unit and a laser-emitting unit disposed at the first optical analysis device case and electrically connected to the data processing unit.

4. The system of claim 1, wherein the positioning unit further includes a positioning member, a hanging structure connecting the positioning member, and a plurality of marking points disposed at the positioning member.

5. The system of claim 4, wherein the marking points are LEDs.

6. The system of claim 4, wherein the marking points are light-reflecting marks.

7. The system of claim 1, wherein the positioning points includes a first positioning point group provided at one end of the syringe and a second positioning point group provided at another end of the syringe.

8. The system of claim 7, wherein the first positioning point group and the second positioning point group are arranged at the syringe in a manner of derangement.

9. The system of claim 7, wherein the first positioning point group and the second positioning point group are arranged at the syringe in a manner of stagger arrangement.

10. The system of claim 7, wherein the first positioning point group and the second positioning point group are arranged at the syringe in a manner of annular arrangement.

11. The system of claim 1, wherein the positioning points are light-reflecting marks.

12. The system of claim 1, wherein the positioning unit is disposed at the tooth and jaw model.

13. A method for virtual reality simulation of local dental anesthesiological techniques and skills training, comprising steps of:
(1) providing a system for virtual reality simulation of local dental anesthesiological techniques and skills training including: a positioning unit; a syringe, having relative movement with the positioning unit, and includes a plurality of positioning points; and an optical analysis device, including a data processing unit, a display unit and an optical positioning module, wherein the display unit and the optical positioning module are electrically connected to the data processing unit, the optical positioning module includes a plurality of optical capturing component for optically scanning the positioning unit and the positioning points of the syringe to output data to the data processing unit;
(2) building an operator injecting process by using the system for virtual reality simulation of local dental anesthesiological techniques and skills training;
(3) digitalizing the operator injecting process by using the system for virtual reality simulation of local dental anesthesiological techniques and skills training;
(4) comparing the digitalized data and a standard needle-penetration process, and digitally displaying the difference between the digitalized data and standard needle-penetration process through the display unit.
(5) calculating the digitalized data of the difference between the digitalized data and the standard needle-penetration process to obtain an analysis result by using the data processing unit of the system for virtual reality simulation of local dental anesthesiological techniques and skills training; and
(6) outputting the analysis result and displaying the analysis result on the display unit.

14. The method of claim 13, wherein the difference includes offset situation assessment of the needle-penetration and needle-insertion point, and whether the operate performance meets the standard requirement.

15. The method of claim 13, wherein the operating process includes error feedback, so user is informed in time that a mistake is made and thus able to adjust his or her operating method according to the feedback.

16. The method of claim 13, wherein the operator injection process includes point of needle-penetration, angle of needle-penetration, direction of needle-penetration, and depth of needle-penetration depth.

17. The method of claim 13, further comprising: a head model member and a tooth and jaw model, wherein the positioning unit is connected to the tooth and jaw model, the head model member includes an oral cavity, the tooth and jaw model is movably disposed inside the oral cavity, and an artificial oral soft tissue is movably disposed at the tooth and jaw model.

18. The method of claim 13, further comprising: a first optical analysis device case, a second optical analysis device case and an light arm set; wherein the data processing unit is accommodated inside the first optical analysis device case, the optical positioning module is disposed inside the second optical analysis device case, and the light arm set is fixed to the first optical analysis device case and movably attached to the second optical analysis device case and the display unit.

19. The method of claim 13, wherein the optical analysis device further includes a light-emitting unit and a laser-emitting unit disposed at the first optical analysis device case and electrically connected to the data processing unit.

20. The method of claim 13, wherein the positioning unit further includes a positioning member, a hanging structure connecting the positioning member, and a plurality of marking points disposed at the positioning member.

21. The method of claim 20, wherein the marking points are LEDs.

22. The method of claim 20, wherein the marking points are light-reflecting marks.

23. The method of claim 13, wherein the positioning points includes a first positioning point group provided at one end of the syringe and a second positioning point group provided at another end of the syringe.

24. The method of claim 23, wherein the first positioning point group and the second positioning point group are arranged at the syringe in a manner of derangement.

25. The method of claim 23, wherein the first positioning point group and the second positioning point group are arranged at the syringe in a manner of stagger arrangement.

26. The method of claim 23, wherein the first positioning point group and the second positioning point group are arranged at the syringe in a manner of annular arrangement.

27. The method of claim 13, wherein the positioning points are light-reflecting marks.

28. The method of claim 13, wherein the positioning unit is disposed at the tooth and jaw model.

29. The method of claim 17, wherein the positioning unit is disposed at the tooth and jaw model.
